(19) United States
(12) Patent Application Publication
(10) Pub. No.: US 2003/0083600 A1
(43) Pub. Date: May 1, 2003

(54) Massage device

(75) Inventors: Wendy Robbins, Pine Mountain, CA (US); Jorli McLain, Pine Mountain, CA (US)

Correspondence Address: DONALD J. LENKSZUS, P.C., P.O. Box 3064, Carefree, AZ, 85377-3064, US

(73) Assignee: EVERYTHING FOR LOVE, INCORPORATED, PINE MOUNTAIN, CA (US)

(21) Appl. No.: 10/179,919

(22) Filed: Jun. 25, 2002

Related U.S. Application Data
(63) Continuation-in-part of application No. 09/621,952, filed on Jul. 21, 2000, now Pat. No. 6,450,980.

(51) Int. Cl. A61H 7/00; A61H 11/00

(52) U.S. Cl. 601/133; 601/137

(57) ABSTRACT

An improved massage device comprises a handle, and a plurality of flexible, elongated members protruding from the handle. The plurality of flexible, extended members extend generally laterally outward from the handle and then downward to form a space of substantially uniform circumference.

### RELATED APPLICATIONS

This is a continuation in part of our prior application Ser. No. 09/621,952 filed Jul. 21, 2000 and titled Massage Device.

### FIELD OF THE INVENTION

The present invention relates to massage devices. More particularly, the invention relates to a massage device having flexible, metallic prongs or fingers.

### BACKGROUND OF THE INVENTION

Our prior patent application describes a massage device that is particularly well adapted for use as a head massage device.

### SUMMARY OF THE INVENTION

A massage device in accordance with the principles of the invention includes a handle, and a plurality of flexible, elongated members protruding from the handle. The plurality of flexible, extended members extend generally laterally outward from the handle and then downward to form a space of substantially uniform circumference.

In one embodiment of the invention the handle is a hollow tubular member that is closed at one end by an end cap. The end cap includes an aperture through which one end of each of the flexible members extends into the hollow tubular member. Each of the ends of the flexible members extending into the handle is affixed into the handle by fastening means disposed in the handle. In one embodiment of the invention, an adhesive filler is utilized to permanently attach the flexible members to the handle.

In accordance with one aspect of the invention, the flexible members are formed from copper wire. The handle in one embodiment is formed from a copper tube. In another embodiment of the invention, the handle is formed of a non-metallic material such as wood or bamboo or other non-metallic material.

A massaging device in accordance with the principles of the invention includes a plurality of resilient fingers each having a first portion extending outward from a central axis and each having a second portion extending downward from the first portion and terminating in a free end. The second portions of said plurality of fingers define a space. The said space terminates in an opening defined by juxtaposition of the free ends of the fingers. The space has a substantially uniform cross-section over substantially its entire length. The opening has a cross-section substantially the same as said uniform cross-section. The free ends of the fingers are used to contact and apply stimulating sensations to a body portion.

In accordance with one aspect of the invention, each finger of the plurality of fingers is resilient so that each corresponding free end may move to conform to the surface of the body portion contacted with the free ends.

In a preferred embodiment of the invention, each free end terminates in a smooth and/or rounded portion In addition, in the preferred embodiment, each finger is wire, and preferably copper wire.

Further in accordance with one aspect of the invention, each finger comprises an end portion extending from the first portion in a direction substantially opposite the corresponding second portion. A handle for gripping and manipulating the massaging device is provided. The end portion of each of the fingers terminates in and is secured within the handle. The handle comprises a tubular hollow portion. Each finger end portion extends into and is affixed to said tubular hollow portion.

In one embodiment of the invention, the handle comprises an insert, that includes the tubular hollow portion.

In an embodiment of the invention, the handle comprises a metallic portion and/or a non-metallic portion.

In accordance with another aspect of the invention, the handle includes an insert member. The insert member may comprise a vibrator.

In a further embodiment of the invention, a massaging device comprises a vibrator, and a plurality of resilient and pliable fingers coupled to the vibrator. Each finger has a free end and an opposite end. The opposite ends are coupled to the vibrator. The fingers define a space of uniform cross-section and extending between the free ends and the opposite ends and have a self-maintained opening at one end formed by a juxtaposition of the free ends. The opening is of the same uniform cross-section. The finger free ends are used to apply pressure and couple vibrations from the vibrator to a body portion.

In accordance with one aspect of the invention the massage device includes a handle and the vibrator is contained in the handle.

In accordance with another aspect of the invention the body portion massaged may be a head; and the uniform cross-section is smaller than the cross-section of the head.

In accordance with the principles of the invention, a massaging device may include a first plurality of resilient fingers each having one portion extending outward from a central axis and each having another portion extending downward from said one portion and terminating in a free end. The another portions of the first plurality of fingers define a space. The space terminates in an opening defined by juxtaposition of the free ends of said fingers. A second plurality of resilient fingers is provided each having one portion extending outward from the central axis and each having another portion extending downward from the one portion and terminating in a free end. The another portion of each of the second plurality of fingers is shorter than the another portions of the fingers of the first plurality of fingers. The free ends of the fingers of the first plurality of fingers and of the second plurality of fingers are used to contact and apply stimulating sensations to a body portion.

In yet another massaging device a handle has a plurality of resilient fingers each having one portion extending outward from said handle and each having another portion extending downward from the one portion and terminating in a free end. The another portions of the first plurality of fingers define a space. The space terminates in an opening. The opening is defined by juxtaposition of the free ends of the fingers. The handle comprises a material that changes color depending upon certain conditions at the surface of the handle.

In another embodiment of the invention, the handle emits light. In certain specific embodiments, the handle comprises a light emitting material.

### BRIEF DESCRIPTION OF THE DRAWINGS

The invention will be better understood from a reading of the following detailed description of several embodiments of the invention in conjunction with the drawing figures, in which like reference designations are used to identify like elements, and in which:

FIG. 1 is a side elevation view of a massage device according to the present invention;

FIG. 2 is a bottom view of the device of FIG. 1;

FIG. 3 is an assembly view of a handle portion of the device of FIG. 1;

FIG. 4 is an end view in the direction of arrow A in FIG. 3 of an end cap of the handle portion of FIG. 3;

FIG. 5 is an end view of a tubular body portion of the handle portion of FIG. 3;

FIG. 6 is an end view of another end cap of the handle portion of FIG. 3 taken in the direction of arrow B of FIG. 3;

FIG. 7 is a sectional view of the end cap of FIG. 6, taken along line 7-7 of FIG. 6;

FIG. 8 is a sectional view taken longitudinally of the massage device of FIG. 1, of one embodiment of the handle construction using an insert member;

FIG. 9 is a sectional view taken longitudinally of the massage device of FIG. 1, of another embodiment of the handle construction using a solid retaining material. 10;

FIG. 10 is a perspective view of another embodiment of the invention;

FIG. 11 is a side view of the embodiment of FIG. 10;

FIG. 12 is a bottom view of the embodiment of FIG. 10;

FIG. 13 is a top view of the embodiment of FIG. 10;

FIG. 14 illustrates one of the fingers of the embodiment of FIG. 10;

FIG. 15 illustrates a section taken across the fingers of the embodiment of FIG. 10 perpendicular to an axis extending through the handle of the embodiment of FIG. 10;

FIG. 16 is a perspective view of a further embodiment of the invention;

FIG. 17 is a side view of yet another embodiment of the invention;

FIGS. 18-21 are each perspective views of further embodiments of the invention.

FIG. 22 is a side view of another embodiment of the invention; and

FIG. 23 is a bottom view of the embodiment of FIG. 22

### DETAILED DESCRIPTION

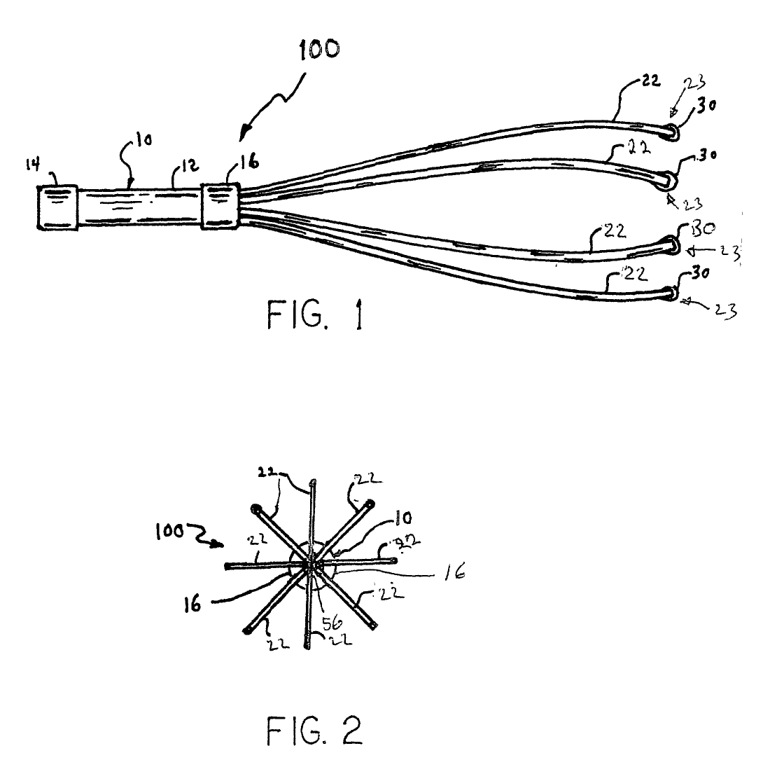

A first massage device 100 is shown in FIG. 1, and includes a handle 10 and a plurality of flexible, elongated members or fingers 22 protruding from the handle 10. Although only four fingers are visible in FIG. 1, the illustrative embodiment of the massage device shown in FIG. 2 has eight fingers. Each of the plurality of flexible, elongated members or fingers 22 are bendable, and may be composed, for example, of copper material or other metal or metal alloy.

The flexible, metallic fingers 22 are preferably sufficiently stiff as to retain their position and shape. They are somewhat resilient, inasmuch as they will return to their initial positions after application of a force thereto less than a bending force. However, upon application of a force sufficient to cause bending, once bent by a user so as to be moved to another position or formed into another shape under a bending force, the flexible, metallic prongs or fingers 22 will stay in that shape.

As shown in FIG. 1, the free end or terminus 23 of each of the flexible, metallic prongs or fingers 22 is rounded over. More specifically, the terminus 23 of each finger 22 has a covering 30. Covering 30 is preferably a soft, resilient plastic coating, to protect the scalp against injury or damage. Covering 30 can be applied to the trips by dipping in liquid plastic material, for example. It is also contemplated as being within the scope of the present invention that each of the coverings 30 could be a pre-molded piece which is slid over respective ones of the tips of the fingers 22 and secured thereon frictionally or by adhesive. All such variations are contemplated as being within the scope of the present invention.

It is contemplated as being within the scope of the present invention that each of the plurality of flexible, elongate members or fingers 22 may be composed of other suitable materials for use as a massage device, for example, flexible plastic or rubber material. All such variations are contemplated as being within the scope of the present invention.

Handle 10 includes a first end cap 14, a tubular body portion 12, and a second end cap 16. The end caps 14 and 16 can, for example, be secured to the tubular body portion 12 by use of mating screw threads. Alternatively, the end caps 14 and 16 can be secured to the tubular body portion 12 by use of glue or adhesive, or by welding or soldering. All such variations are contemplated as being within the scope of the present invention.

FIG. 2, which is an end elevations view of the device of FIG. 1 as seen from the right side thereof, shows an additional four flexible, metallic prongs or fingers 22. As seen in FIG. 2, the flexible, metallic prongs or fingers 22 extend from an aperture 56 in end wall 58 or cap 16 approximately equi-angularly from the end cap 16 of the handle 10.

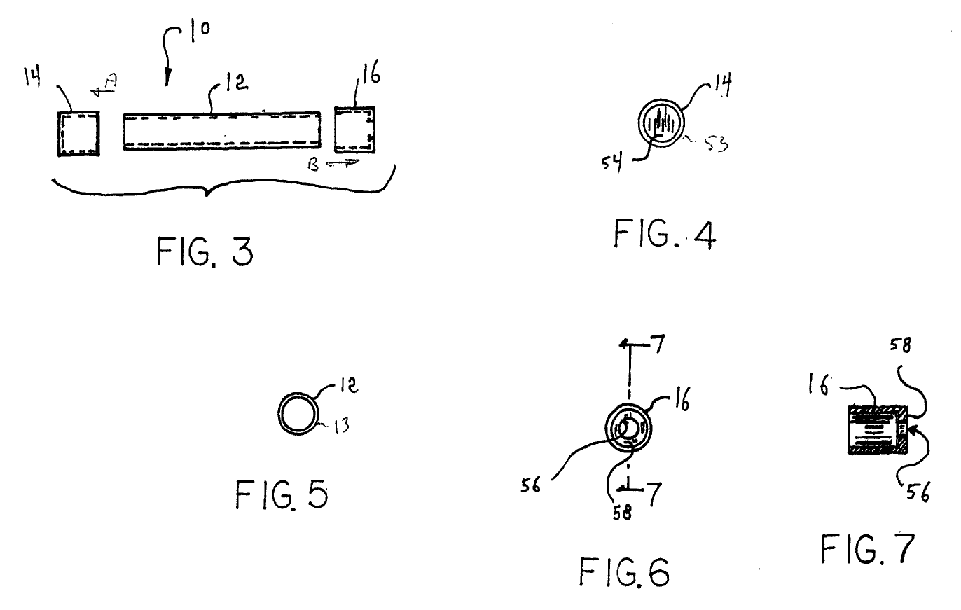

Handle portion 10 is shown in exploded view in FIG. 3 to more clearly illustrate the use of end caps 14, 16 along with tubular portion 12.

FIG. 4 is an end view of end cap 14. As seen in this view, the end cap 14 has a peripheral tubular wall 53 and a solid end face 54. When end cap 14 is assembled onto tubular body portion 12, the interior of tubular wall 53 is affixed to the exterior surface 13 of tubular body portion 12. The affixation may be provided by the use of any of a number of conventional means and methods of affixation, including, but not limited to the use of adhesive, mating screw threads, soldering, welding, brazing, and pressure fit.

FIG. 5 is an end view of the tubular body portion 12 of the handle portion 10 of FIG. 3. As seen in this view, the tubular body portion 12 has a hollow cylindrical shape.

End cap 16 as shown in FIGS. 6 and 7 has a peripheral tubular wall 57 and an end face 58. The end face 58 has an aperture 56 formed there through. Just as with end cap 14, end cap 16 is affixed to tubular body portion 12.

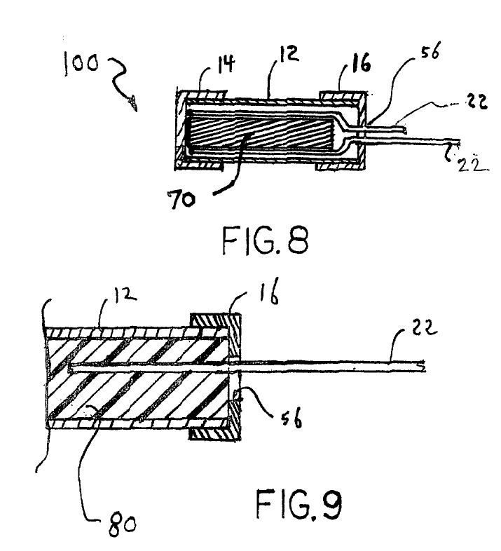

FIG. 8 is a sectional view taken longitudinally of the massage device 100 of FIG. 1, of one embodiment of the construction of the handle 10. In this embodiment, an insert member 70 is provided. The insert member 70 is provided to secure the flexible, metallic prongs or fingers 22 inside handle 10. For the sake of clarity, only two of the flexible, metallic prongs or fingers 22 are shown in this view. Also for the sake of clarity, the size of the insert member 70 is schematically shown in this view, and is not to scale with the other parts. The insert member 70 in practice will be sufficiently large that, when end cap 14 and end cap 16 are secured to tubular body portion 12, the flexible, metallic prongs or fingers 22 will be secured within handle 10, by, for example, being compressed between the insert member 70 and the end cap 14, the end cap 16, and the tubular body portion 12. Other types of compression fitting are known, and all such variations are contemplated as being within the scope of the present invention. Fingers 22 extend from the interior of handle 10 through aperture 56 of end cap 16.

In addition, insert member 70 in another embodiment of the invention, rather than being a solid member may be a vibrator unit, of a type that is commercially available. By utilizing a vibrator unit, as insert 70, the massage sensations provided by fingers 12 is enhanced.

FIG. 9 is a sectional view taken longitudinally of the massage device 100 of FIG. 1, of another embodiment of the construction of the handle 10 using a solid retaining material 80 therein. In this embodiment, the solid retaining material 80 is provided to secure the flexible, metallic prongs or fingers 22 to the interior of handle 10. The solid retaining material 80 is provided to secure the flexible, metallic prongs or fingers 22 into handle 10. For the sake of clarity, only one of the flexible, metallic prongs or fingers 22 is shown in this view. The plurality of flexible, metallic prongs or fingers 22 thereby attached to handle 10 by the solid resilient filler material (solid retaining material) 80, which may be solidified around the plurality of flexible, elongated members. For example, rubber or plastic may be used in liquid form by pouring or injection into the tubular body portion 12, and then permitted to solidify or harden. All such variations are contemplated as being within the scope of the present invention.

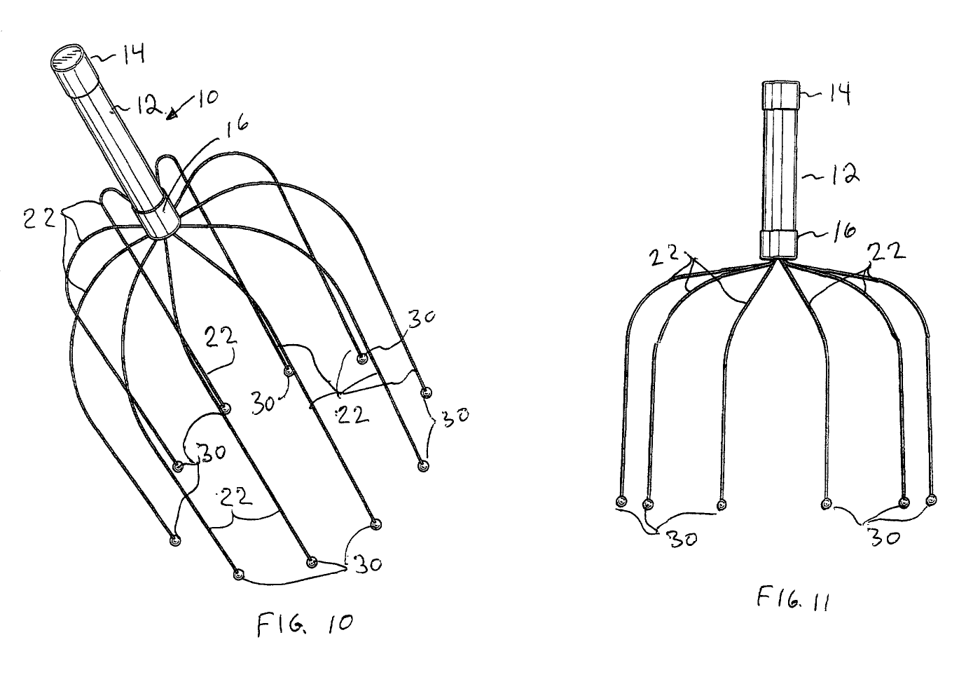

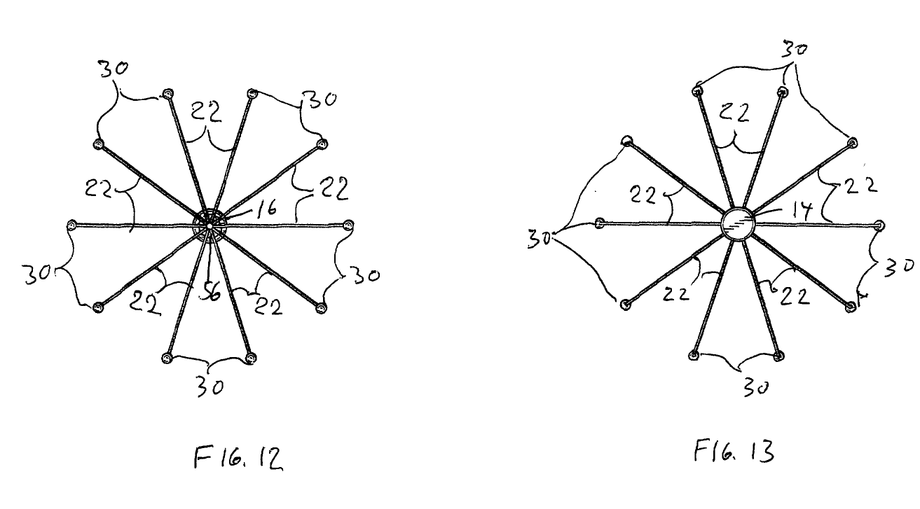

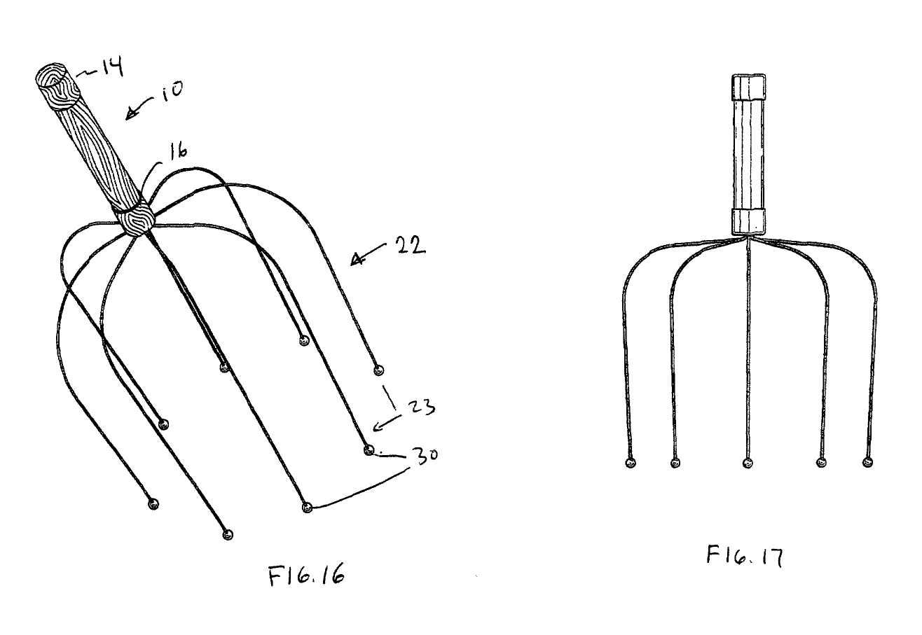

FIGS. 10 to 14 illustrate another embodiment of the invention. Yet a further embodiment of the invention is shown in each of FIGS. 15-20. Each of the embodiments of FIGS. 10-20 is characterized in that the flexible metallic prongs or fingers 22 extend away from the handle 10 in such a way as to define a cavity 100 of uniform cross-section terminating in an opening having the same cross-section.

A massage device 1000 shown in FIGS. 10 through 13 includes a handle 10 and a plurality of flexible, elongated members 22 protruding from the handle 10. Each of the plurality of flexible, elongated members 22 is bendable, and may be composed, for example, of copper material or other metal or metal alloy.

The flexible, metallic prongs or fingers 22 are each preferably sufficiently stiff as to retain their position and shape. They are somewhat resilient, inasmuch as they will return to their initial positions after application of a force thereto less than a bending force. However, upon application of a force sufficient to cause bending, once bent by a user so as to be moved to another position or formed into another shape under a bending force, each flexible, metallic prongs or fingers 22 will stay in that shape.

Each flexible, metallic prong or finger 22 terminates at its free end 26 in a covering 30. Specifically, each flexible, metallic prong or finger 22 has a respective covering 30. Each covering 30 is preferably a soft, resilient plastic coating, to protect the scalp against injury or damage. Covering 30 can be applied to the trips by dipping in liquid plastic material, for example. It is also contemplated as being within the scope of the present invention that each of the coverings 30 could be a pre-molded piece which is slid over respective ones of the tips of fingers 22 and secured thereon frictionally or by adhesive. All such variations are contemplated as being within the scope of the present invention.

Handle 10 includes an end cap 14, a tubular body portion 12, and an end cap 16. End caps 14 and 16 are secured to tubular body portion 12. Each finger 22 has its upper end portion extending through an aperture 56 of end cap 16 into tubular body portion 12. The upper end portions of fingers 22 terminate in tubular body portion 12 and within the tubular body portion 12 are secured to the tubular body portion 12. Various ways of securing the upper end portions within and to the tubular body portion 12 including use of compressing devices and poured compounds as described above. In addition, the upper end portions may be secured within tubular body portion 12 by means of adhesive or bonding agents, including, but not limited to, solder.

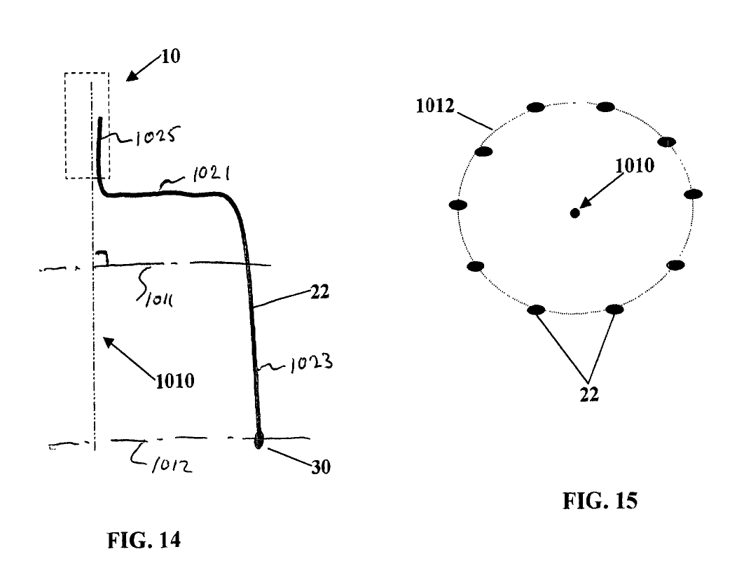

As more clearly shown in FIG. 14, each finger 22 has a portion 1021 that extends substantially radially outward from handle 10 and its axis 1010. Finger 22 has a second portion 22 that extends downward from portion 1021 and substantially parallel to axis 1010. Finger 22 includes a further portion 1025 that extends upward from portion 1021 into handle 10 wherein it is secured to handle 10.

One aspect of the invention is illustrated in FIG. 15. When a cross section is taken through the space defined by the portions 1023 of fingers 22 at any plane 1011 that is perpendicular to axis 1010, the cross sections will be substantially uniform for all planes taken along axis 1010. Thus a cross-section defined by fingers 22 in plane 1011 will have the same cross-section as defined by fingers 22 in plane 1012.

A further advantageous embodiment of the invention is shown in FIG. 16. In the device of FIG. 16, eight fingers 22 are provided and handle 10 is formed of a non-metallic material which may be an organic material such as wood or bamboo. Other non-metallic materials such as plastic may also be used for handle 10. Handle 10 comprises a body portion 12 that includes a cavity, which is not shown, for receiving the upper end portions of fingers 22. End caps 14, 16 are provided and may be of the same or a different material as the body potion 12 although in the specific embodiment shown, the end caps 14, 16 are of the same material ad body portion 12. As with the device of FIGS. 10-15, fingers 22 are configured so as to define a space or cavity of substantially uniform cross section from the cavity opening defined by the free ends 23 of fingers 22. Each finger 22 includes an upper portion that extends into handle 10 substantially parallel to the longitudinal axis of handle 10. Each finger has a portion extending outward from handle 10 and a third portion extending downward and substantially parallel to the longitudinal axis of handle 10.

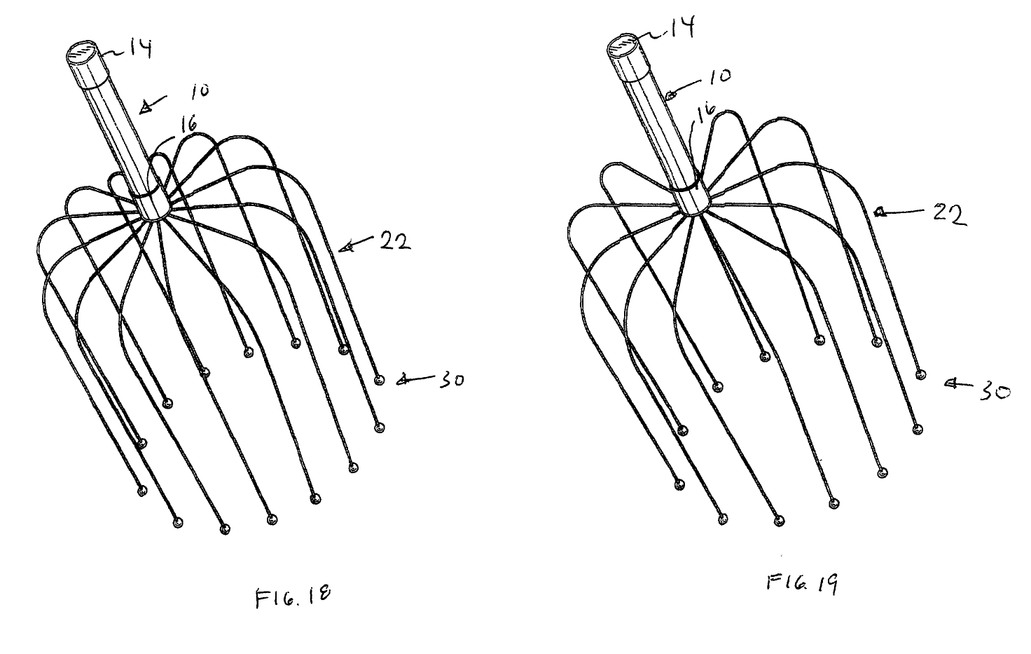

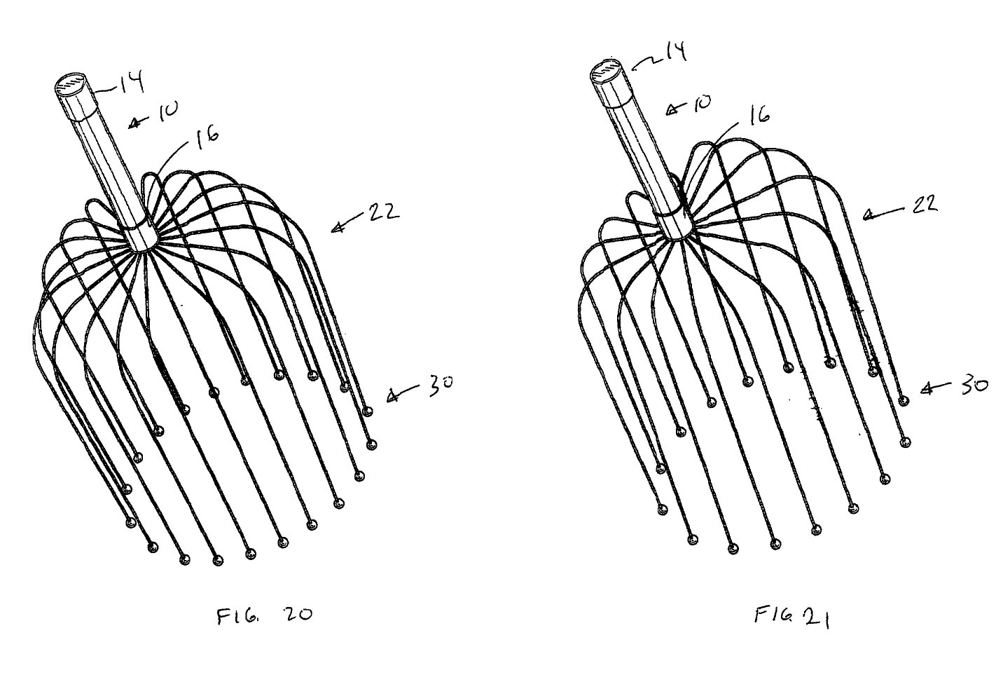

The embodiments of the invention shown in FIGS. 17 through 21 are similar to that shown in FIG. 10. The embodiment of FIG. 17 includes 12 fingers; the embodiment of FIG. 18 includes 14 fingers; the embodiment of FIG. 19 includes 16 fingers; the embodiment of FIG. 20 includes 18 fingers, and the embodiment of FIG. 21 includes 20 fingers. As with the embodiment of FIG and that of FIG. 16, each of the embodiments of FIGS. 17 through 21 are configured such that the fingers 22 include a portion extending into the respective handles substantially parallel to the longitudinal axis of the handle; a portion extending outward from the handle; and a portion extending substantially parallel to the longitudinal axis of the handle such that the fingers define a space or cavity of substantially uniform cross-section over the entirety of the third portions of the fingers including the opening of the cavity defined by the free ends of the fingers 22.

Turning now to FIG. 21 handle portion 10 may, in certain embodiments include a sleeve 201 that is retained within handle portion 10. Sleeve 201 may be a metallic tube to which the ends of fingers 22 are attached. Any one of a number of means of attachment may be used. However, soldering, brazing and welding are preferred means of attachment where the sleeve is a metallic tube. One advantage of utilizing a metallic sleeve is that handles may then be utilized that might not have desired strength. Metallic sleeve may be keyed with a key 203 that engages a matching slot 204 in handle portion 10 to thereby help secure the sleeve in position. End cap 16 may still be utilized in conjunction with the sleeve to help retain sleeve 201 in handle 10.

As noted in conjunction with the embodiment of FIG. 1, a vibrator unit may be provided in handle 10 of any of the embodiments shown. Alternatively, the vibrator unit may be provided outside of the handle.

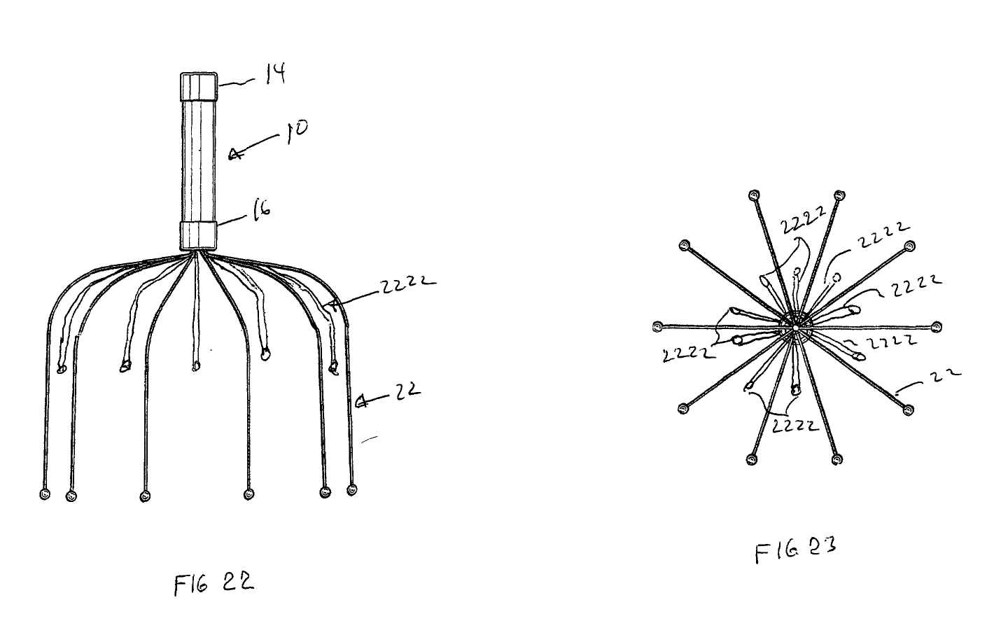

Turning now to FIG. 22, a further improved massage device in accordance with the principles of the invention is shown that is similar to the devices already shown and described except that in addition to the first plurality of fingers 22, a second plurality of fingers 2222 are provided. Each of the additional fingers 2222 is shorter than the fingers of the first plurality of fingers. The additional fingers are disposed within the space defined by fingers 22. With the additional fingers 2222, the top of a head may be simultaneously massaged simultaneous with the fingers massaging the remainder of the head, thereby increasing the pleasurable benefits of the massage. Each of the fingers 2222 terminates in a rounded free end as with fingers 22. In addition, each finger 2222 includes a portion that extends into and is secured in handle 10.

In yet further embodiments of the invention, the handle is comprised of material that glows in the dark to make the device more visible in darkened rooms. Such materials are known and are typically plastic material. In still further embodiments of the invention, the handle includes at least a portion comprised of a material that indicates the mode of the user by changes in color. Such mood indicating materials are typically temperature sensitive and change color depending on the surface temperature of the material.

Those skilled in the art will realize that the invention is not limited to the embodiments shown and that various modifications and changes may be made to the illustrative embodiments without departing from the spirit or scope of the invention. It is not intended that the invention be limited to the embodiments shown and described, but rather it is intended that the invention be limited in scope only by the claims appended hereto.

What is claimed is:

1. A massaging device comprising:
a plurality of resilient fingers each having one portion extending outward from a central axis and each having another portion extending downward from said one portion and terminating in a free end, said another portion of said plurality of fingers defining a space, said space terminating in an opening, said opening being defined by juxtaposition of said free ends of said fingers; said space having a substantially uniform cross-section over substantially its entire length; said opening defining a cross-section substantially the same as said uniform cross-section; said free ends of said fingers being used to contact and apply stimulating sensations to a body portion.

2. A massage device in accordance with claim 1, wherein:
each finger of said plurality of fingers is resilient so that each corresponding end may move to conform to the surface of a body part in contact with said free ends of said plurality of resilient fingers.

3. A massage device in accordance with claim 1, wherein:
said free end of each finger terminates in a smooth portion.

4. A massage device in accordance with claim 1, wherein:
said fingers each comprise wire.

5. A massage device in accordance with claim 1, wherein:
said fingers comprise copper wire.

6. A massage device in accordance with claim 1 wherein:
each said free end terminates in a rounded portion.

7. A massage device in accordance with claim 1, wherein:
said fingers are electrically conductive.

8. A massage device in accordance with claim 2, wherein:
said fingers each comprise wire.

9. A massage device in accordance with claim 2, wherein:
said fingers are electrically conductive.

10. A massage device in accordance with claim 2, wherein:
said fingers comprise copper wire.

11. A massage device in accordance with claim 1, wherein:
the number of said plurality of fingers is within the range of 8 to 20 fingers.

12. A massage device in accordance with claim 1, wherein:
each of said fingers each further comprises an end portion extending from said one portion in a direction substantially opposite the corresponding said another portion.

13. A massage device in accordance with claim 12, comprising:
a handle for gripping and manipulating said massaging device; and wherein
said end portion of each of said fingers terminates in and is secured within said handle.

14. A massage device in accordance with claim 13 wherein:
said handle comprises a tubular hollow portion; and
each said end portion extends into and is affixed to said tubular hollow portion.

15. A massage device in accordance with claim 14, wherein:
said handle comprises an insert, said insert comprising said tubular hollow portion.

16. A massage device in accordance with claim 14, wherein:
said handle comprises a metallic portion.

17. A massage device in accordance with claim 16, wherein:
said handle comprises a non-metallic portion.

18. A massage device in accordance with claim 14, wherein:
said handle comprises a non-metallic portion.

19. A massage device in accordance with claim 1, wherein:
the number of said fingers of said plurality of fingers is no more than 24.

20. A massage device in accordance with claim 1, wherein:
the number of fingers of said plurality of fingers comprises at least 8 and no more than 24.

21. A massage device in accordance with claim 13, wherein:
said handle comprises an organic material portion.

22. A massage device in accordance with claim 21, wherein:
said or

21. A massaging device comprising:
a handle having a hollow portion;
a plurality of resilient and pliable fingers, said fingers each having a free end and an opposite end, each said opposite end being secured in said hollow portion, said fingers defining a space of uniform cross-section and extending between said free ends and said opposite ends and having a self-maintained opening at one end formed by a juxtaposition of said free ends, said opening being of said uniform cross-section, said uniform cross-section being smaller than a cross section of a head, whereby said fingers flex outward to so that a head can enter and fit inside said space with said free ends in contact with said head when said device is lowered on to said head so that said head enters said head-receiving space through said opening, and said free ends of said fingers apply pressure to and thus massage said head.

22. A massage device in accordance with claim 21, wherein:
each said free end of each said finger is smoothly terminated.

23. A massage device in accordance with claim 21, wherein:
each said free end is terminated in a bulb or ball-like structure.

24. A massage device in accordance with claim 21, wherein:
said device comprises from four to twenty-four said fingers.

25. A massage device in accordance with claim 21, wherein:
said handle comprises a metallic portion.

26. A massage device in accordance with claim 21, wherein:
said handle comprises a non-metallic portion.

27. A massage device in accordance with claim 26, wherein:
said non-metallic portion comprises wood.

28. A massage device in accordance with claim 26, wherein:
said non-metallic portion comprises a plastic material.

29. A massage device in accordance with claim 26, wherein:
said non-metallic portion comprises an organic material.

30. A massage device in accordance with claim 26, wherein:
said handle comprises a metallic end cap, said end cap having an aperture; and
said finger opposite ends extending through said aperture into said handle.

31. A massaging device comprising:
a plurality of resilient fingers each having one portion extending outward from a central axis and each having another portion extending downward from said one portion and terminating in a free end, said another portion of said plurality of fingers defining a space, said space terminating in an opening, said opening being defined by juxtaposition of said free ends of said fingers; said space having a substantially uniform cross-section over substantially its entire length; said free ends of said fingers being used to contact and apply stimulating sensations to a body portion.

32. A massage device in accordance with claim 31, wherein:
each finger of said plurality of fingers is resilient so that each corresponding end may move to conform to the surface of a body part in contact with said free ends of said plurality of resilient fingers.

33. A massage device in accordance with claim 31, wherein:
said free end of each finger terminates in a smooth portion.

34. A massage device in accordance with claim 31, wherein.
said fingers each comprise wire.

35. A massage device in accordance with claim 31, wherein:
said fingers comprise copper wire.

36. A massage device in accordance with claim 31 wherein:
each said free end terminates in a rounded portion.

37. A massage device in accordance with claim 31, wherein:
said fingers are electrically conductive.

38. A massage device in accordance with claim 32, wherein:
said fingers each comprises wire.

39. A massage device in accordance with claim 32, wherein:
said fingers are electrically conductive.

40. A massage device in accordance with claim 32, wherein:
said fingers comprise copper wire.

41. A massage device in accordance with claim 31, wherein:
the number of said plurality of fingers is within the range of 8 to 20 fingers.

42. A massage device in accordance with claim 31, wherein:
each of said fingers each further comprises an end portion extending from said one portion in a direction substantially opposite the corresponding said another portion.

43. A massage device in accordance with claim 42, comprising:
a handle for gripping and manipulating said massaging device; and wherein
said end portion of each of said fingers terminates in and is secured within said handle.

44. A massage device in accordance with claim 43 wherein:
said handle comprises a tubular hollow portion; and
each said end portion extends into and is affixed to said tubular hollow portion.

45. A massage device in accordance with claim 44, wherein:
said handle comprises an insert, said insert comprising said tubular hollow portion.

46. A massage device in accordance with claim 44, wherein:
said handle comprises a metallic portion.

47. A massage device in accordance with claim 46, wherein:
said handle comprises a non-metallic portion.

48. A massage device in accordance with claim 44, wherein:
said handle comprises a non-metallic portion.

49. A massage device in accordance with claim 31, wherein:
the number of said fingers of said plurality of fingers is no more than 24.

50. A massage device in accordance with claim 31, wherein:
the number of fingers of said plurality of fingers comprises at least 8 and no more than 24.

51. A massaging device comprising:
a vibrator;
a plurality of resilient and pliable fingers, said fingers each having a free end and an opposite end, each said opposite end being coupled to a said vibrator, said fingers defining a space of uniform cross-section and extending between said free ends and said opposite ends and having a self-maintained opening at one end formed by a juxtaposition of said free ends, said opening being of said uniform cross-section, said finger free ends being used to apply pressure and couple vibrations from said vibrator to a body portion.

52. A massage device in accordance with claim 51, comprising:
a handle;
said vibrator being contained in said handle.

53. A massage device in accordance with claim 51, wherein:
said body portion may be a head; and
said uniform cross-section is smaller than the cross-section of said head.

54. A massage device in accordance with claim 51, comprising:
a handle, said handle comprising a cavity, said vibrator being contained in said cavity.

55. A massage device in accordance with claim 54, wherein:
each said finger opposite end extending into said cavity and being affixed therein to said handle.

56. A massage device in accordance with claim 55, comprising:
an end cap disposed on one end of said handle, said end cap having an aperture; said opposite ends extending through said aperture into said handle.

57. A massage device in accordance with claim 56, wherein:
said handle comprise a non-metallic portion.

58. A massage device in accordance with claim 57, wherein:
said end cap is metallic.

59. A massage device in accordance with claim 57, wherein:
said end cap is copper.

60. A massaging device comprising:
a first plurality of resilient fingers each having one portion extending outward from a central axis and each having another portion extending downward from said one portion and terminating in a free end, said another portions of said first plurality of fingers defining a space, said space terminating in an opening, said opening being defined by juxtaposition of said free ends of said fingers; and
a second plurality of resilient fingers each having one portion extending outward from said central axis and each having another portion extending downward from said one portion and terminating in a free end, said another portion of each of said second plurality of fingers being shorter than said another portions of said fingers of said first plurality of fingers;
said free ends of said fingers of said first plurality of fingers and of said second plurality of fingers being used to contact and apply stimulating sensations to a body portion.

61. A massaging device in accordance with claim 60, wherein:
said space has a substantially uniform cross-section over substantially its entire length; said opening defining a cross-section substantially the same as said uniform cross-section.

62. A massaging device in accordance with claim 60 comprising:
a vibrator coupled to said first and second plurality of resilient fingers.

63. A massaging device comprising:
a handle;
a plurality of resilient fingers each having one portion extending outward from said handle and each having another portion extending downward from said one portion and terminating in a free end, said another portions of said first plurality of fingers defining a space, said space terminating in an opening, said opening being defined by juxtaposition of said free ends of said fingers; and
wherein said handle comprises a material that changes color depending upon certain conditions at the surface of said handle.

64. A massaging device comprising:
a handle,
a plurality of resilient fingers each having one portion extending outward from said handle and each having another portion extending downward from said one portion and terminating in a free end, said another portions of said first plurality of fingers defining a space, said space terminating in an opening, said opening being defined by juxtaposition of said free ends of said fingers; and
wherein said handle emits light.

65. A massaging device in accordance with claim 64, wherein:
said handle comprises a light emitting material.
